(19) United States
(12) Patent Application Publication
(10) Pub. No.: US 2020/0077767 A1
(43) Pub. Date: Mar. 12, 2020

(54) DISPENSING A FRAGRANCE BLEND

(71) Applicant: NOUSTIQUE PERFUMES, S.L., Barcelona (ES)

(72) Inventors: Maria Carmen ARTAL LAHOZ, Zaragoza (ES); Manuel GIMENO ASIN, Zaragoza (ES); Hugo LASALA ALONSO, Zaragoza (ES); Javier SANZ NAVAL, Zaragoza (ES); Alvaro SUAREZ IRIBARNE, München (DE)

(21) Appl. No.: 16/469,577

(22) PCT Filed: Dec. 1, 2017
(86) PCT No.: PCT/EP2017/081240

§ 371 Date: Jun. 13, 2019

(30) Foreign Application Priority Data
Dec. 16, 2016 (EP) 16382609.2
Dec. 16, 2016 (ES) P201631601

(51) Int. Cl. A45D 34/02; B67D 7/74

(52) U.S. Cl. CPC A45D 34/02; B67D 7/74

(57) ABSTRACT

A method is used for dispensing a fragrance blend (FB) comprising at least one fragrance (F1, F2), wherein the method comprises, by a fragrance dispensing apparatus (1), offering at least one desired agent function for user selection and blending at least one fragrance (F1, F2) with at least one functional agent (F3) based on at least one selected agent function to obtain the fragrance blend (FB) and dispensing the fragrance blend (FB). A fragrance dispensing apparatus (1) is adapted to perform the method. The invention is particularly useful for selecting and producing a fragrance blend directly by a user.

The invention relates to a method for dispensing a fragrance blend comprising at least one fragrance, wherein the method comprises, by use of a fragrance dispensing apparatus: blending at least one fragrance with at least one functional agent to obtain the fragrance blend and dispensing the fragrance blend. The invention also relates to a fragrance dispensing apparatus, comprising at least one seat for at last one fragrance reservoir and at least one functional agent reservoir, a user interface for selecting at least one fragrance and at least one agent function, at least one extraction means for extracting the selected at least one fragrance from the at least one fragrance reservoir and for extracting at least one functional agent corresponding to the selected at least one agent function from the at least one functional agent reservoir, and a fragrance dispenser for dispensing a fragrance blend blended from the extracted at least one fragrance and at least one functional agent. The invention is particularly useful for selecting and producing a fragrance blend directly by a user.

NZ 607 641 A discloses a container system for liquids such as spray fragrances. The system includes a parent container and a child container. The parent container provides a first cavity for confining a liquid, and couples detachably to the child container for refilling the child container through a supply opening in the parent container. The child container can be used for instance as a travel pack in a handbag or hand luggage. Here the child container is a compact dispenser, comprising a bowl-shaped rigid container having a refill opening, which is kept closed by a valve unless the dispenser is connected to the parent container, and a dispensing opening. These openings are located apart from each other.

A pump dispenses liquid from the dispense opening. In a particularly simple construction, the opening of the bowl is covered by a deformable membrane to form a closed dispense cavity, the cavity becoming mainly or completely evacuated as the dispensing means is operated. The membrane then relaxes again, filling the dispenser, when the dispenser is re-applied to the parent container.

CN 202 687 926 U discloses a perfume filling machine, which comprises a support, a towing bracket arranged in the support, a filling frame arranged at the top of the support, more than one injection device arranged on the filling frame, and a perfume box arranged on one side of the support, wherein a pump body is arranged on the right side in the filling frame, the pump body is connected with the perfume box through a conduit, and the pump body is connected with more than one water pipe. According to the utility model, multiple perfumes can be filled simultaneously, so that the filling efficiency is improved.

CN 202 400 818 U discloses a valve provided with a pipeline and applicable for fragrance sliding way filling. The valve comprises a handle switch which is arranged on the valve; the valve also comprises a pipeline, wherein the valve is arranged on the pipeline; the valve is closed when the handle switch is parallel to the pipeline; and the valve is opened when the handle switch and the pipeline incline. The valve provided with the pipeline is simple in structure and convenient to operate; the accident of fragrance leakage resulted from misopening caused by the collision of the handle when sliding downwards along the sliding way; the environment pollution and the cost are reduced; and meanwhile, the pipeline and the valve are fixedly connected, so that the installation time is reduced, the production efficiency is improved greatly, and the production cost is saved.

CN 201 099 609 Y discloses a filling machine for filling drink and flavour into liquid container (as glass bottle), which comprises a frame, a transmission system and a rotary platform. The utility model is characterized in that each filling valve is provided with a temporary liquid storage barrel, a rotary portion control system uses a Siemens wireless PROFINET communication system (industrial wireless Ethernet) which comprises a positioning device, a probe, a wireless access end and a wireless client end, whose signal processing is completed by periphery control system and operation is processed on a touch screen. The filling machine has reasonable structure and high automatic degrees, without explosion and leakage, while the filling capacity has large adjusting range (50-2000 ml) and the filling accuracy is high as +/−0.5 ml in 500 ml.

U.S. Pat. No. 5,713,403 relates to a method which simplifies the preparation of packaging units which contain different filling products. It is characterized by the fact that to fill the containers according to a specified or selected filling formation with different filling products, i.e. optionally with at least a first or a second filling product, the filling machine is controlled by a control device so that, as a function of the filling formation, the filling positions dispense different products into containers which are unique and appropriate to each product.

U.S. Pat. No. 6,371,451 discloses a scent diffusion apparatus and method that contains individual original scents for a plurality of scents to be diffused, constructs information on position information of the contained original scents and information on various scents to be diffused in a database, and mixes the original scents of the desired scent properly at a desired point in time based on the scent information, to thereby spray the desired scent. The scent diffusion method includes providing a plurality of scent spraying units containing original scents, heating the original scents via a heater, evaporating the original scents, and diffusing the evaporated scent with the air via an air supply pump. Thus, a desired scent can be transferred to a selected subject under correct concentration. The scent diffusion apparatus uses scent cartridges containing the original scents, such as cartridges used in an existing ink-jet printer, and uses the same control commands as those of a general personal computer or ink-jet printer compatibly. Thus, the scent diffusion apparatus can control an amount of diffusion precisely, be manufactured in a compact fashion, and used in connection with a general purpose computer in which almost all kinds of operating systems supporting an ink-jet printer are incorporated.

US 2012/247613 A1 discloses a vending machine for dispensing a selected blend of perfumes in response to the deposit of a pre-selected sum of money. The vending machine includes a plurality of containers and a plurality of distinctive scents with one of the scents disposed in each of the containers. A mechanism for selecting one or more of the scents and an amount of one or more of the scents is provided. Further, the vending machine includes a mechanism for blending the selected scents in the selected percentages and providing a sample to a perspective customer. Further, the mechanism includes a slot receiving payment for a quantity of the selected blend together with a delivery process for providing a bottle of the selected perfume to the customer.

US 2016/045838 A1 discloses an aroma substance delivery device adapted to deliver an aroma substance exclusively to the nasal cavities of an individual, comprising the following elements: (i) a source of carrier gas flow; (ii) regulating means which receives the carrier gas flow and regulates its passage through a plurality of channels; (iii) downstream of the regulating means a plurality of aroma substance-containing cartridges, one being associated with each channel, and (iv) disseminating means located in close proximity to the cartridges and adapted to deliver the individual aroma substances from the cartridges to nasal cavities by means of a conduit; there being positioned in each channel on the upstream side and in close proximity to the origin of the channel a flow restrictor, the flow restrictor being configured such that the pressure drop across the flow restrictor is higher than the pressure drop across the rest of the device. The device is particularly useful as an element in conjunction with an audio-visual display, to provide a complete sensory experience.

It is the object of the present invention to at least partially overcome the problems associated with the prior art. It is a particular object of the present invention to provide improved fragrance(s) in a particularly flexible and user-friendly manner.

The object is achieved according to the features of the independent claims. Advantageous embodiments can be found, e.g., in the dependent claims, in the subsequent description and in the attached drawing.

The object is achieved by a method for dispensing a blend (“fragrance blend”) comprising at least one fragrance, the method comprising: blending, by a fragrance dispensing apparatus, at least one fragrance with at least one functional agent to obtain the fragrance blend; and dispensing, by the fragrance dispensing apparatus, the fragrance blend.

This method gives the advantage that a fragrance blend can have additional functions besides providing a desired odour. This method is realizable in a particularly flexible and user-friendly manner.

A fragrance's primary purpose is to provide a pleasant odour to a user for aesthetic (“non-functional”) olfactory purposes. A functional agent's primary purpose is to provide a non-aesthetic function to the user. At least one functional agent may be an odourless agent. This gives the advantage that the agent function can be selected independently from the desired scent. Additionally or alternatively, at least one functional agent may have an odour. A fragrance may also be a functional agent and a functional agent may have a significant olfactory effect, respectively (“dual purpose agent”). The dual purpose agent may primarily be selected for its non-aesthetic function.

In the following, fragrances and functional agents may summarily be called “active ingredients”. If other ingredients like additional solvent, fixative etc. are added to the fragrance blend, the active ingredients and the other ingredients may summarily be called “blend components”.

The functional agent may in particular be a scent. A functional scent may work or function by being smelled (e.g. by causing an unconscious olfactory effect) or by being inhaled (e.g. by being resorbed in the lungs). Alternatively or additionally, the functional agent may work or function by external administration. The external administration may include application of the functional agent to a user's skin, hair, clothing etc. The externally applied functional agent may work by resorption through the skin. Generally, functional agents may have psychological and/or physiological effects.

The odour of the fragrance blend may be overwhelmingly or entirely be determined by the at least one fragrance's odour.

Dispensing the fragrance blend may include filling a bottle with the fragrance blend, directly spraying the fragrance blend, providing a test strip or test tube comprising the fragrance blend etc. alone or in any combination.

It is an embodiment that at least one functional agent is a mood altering agent, in particular scent. Thus, the fragrance blend may enhance a user's mood, feeling or emotion. The mood altering agent may be provided for stimulating or reducing one or more of the following moods: alertness/tiredness, emotional balance (relaxation)/uneasiness, stress etc. For example, the mood altering agent may cause a user to relax.

It is an embodiment that at least one functional agent is an anti-aging agent, in particular an anti-aging scent. The anti-aging agent can e.g. be used for improving or preserving a skin quality. For example, hyaluronic acid plays a key role in maintaining the moisture and firmness of skin. Research has shown that certain aromatic compounds can encourage the production of hyaluronic acid within skin cells. These aromatic compounds may be used as or with anti-aging scents. They may include the essential oil of immortelle, a plant of the sunflower family commonly found in Mediterranean coastlands, and/or the aromatic compounds of the stamens of the saffron flower. Alternatively or additionally, the anti-aging agent may directly affect the skin area on which the fragrance blend has been applied to, e.g. by moisturization, providing nutrients for the skin etc.

It is an embodiment that at least one functional agent is a dieting scent, e.g. a scent stimulating or curbing a user's appetite. For example, the dieting scent may curb appetite caused by overindulgence in food and drink as response to stress. One such dieting scent may be sweet Osmanthus (Osmanthus fragrans) that curbs the appetite and produces a sense of fullness. Research has shown that, when test subjects inhaled sweet Osmanthus, their physical conditions improved, their body weights and body mass ratios tended to decrease, and they self-reported feelings of satiation both before and after eating.

It is an embodiment that at least one functional agent is a hormone balance agent, in particular scent, i.e. an agent that helps to achieve hormonal balance. The scent of saffron flowers, for example, shows a promising quasi-therapeutic functionality as a promoter of female hormonal balance and as an alleviator of stress. The psychological effects of such hormone balance scents may be linked to physiological effects beneficial to both beauty and general health.

It is an embodiment that at least one functional agent is a memory triggering scent. For example, the web page “www.psychologytoday.com/blog/brain-babble/201501/smells-ring-bells-how-smell-triggers-memories-and-emotions” describes studies that analyse beneficial effects of functional agents implicated in emotions and memory. It is even possible to use these scents for therapeutic purposes.

The functional agent(s) may further be one or more of the followings agents:

Hair care agents. Most common fragrances are not recommended to be applied to hair due to possible damage. Hair care agents may be designed to counter these negative effects of the fragrance(s). Additionally or alternatively, hair care agents may be or comprise nutritional compounds. Additionally or alternatively, hair care agents may have or provide an anti-lice functionality, an anti-dandruff functionality and/or an anti-break functionality etc. Such hair care agents may provide their functionality by direct exposure to hair or skin.

Textile care agents. Most common fragrances are not recommended to be applied to textiles. Textile care agents may be designed to counter these negative effects of the fragrance(s). Additionally or alternatively, textile care agents may have or provide an UV protection functionality, an insect (e.g. mosquito) repellent functionality, an anti-sweat functionality, an antimicrobial functionality and/or an anti-pollution functionality etc.

Generally, the fragrance blend may be blended for use with humans but also with pets, e.g. cats or dogs.

It is an embodiment that the fragrance dispensing apparatus adds at least one functional agent to the fragrance blend based on user selection, e.g. via a user interface. To this effect, “adding at least one functional agent” may include offering the user to add or select one or more agent functions and/or functional agents to the fragrance blend. The user may generally confirm or cancel adding the at least one agent function or functional agent.

In one variation, after selection of the agent function(s), the fragrance dispensing apparatus may offer the user to add or select one or more suitable functional agents. In another variation, the offer includes a selection of at least one agent function. The fragrance dispensing apparatus may then automatically choose at least one functional agent that fulfills the selected agent function, in particular if there is only one functional agent to fulfil the selected agent function. It is thus an embodiment that the offering, by the fragrance dispensing apparatus, to add at least one desired agent function is followed by offering to add at least one functional agent corresponding to the at least one selected agent function.

User-selecting an agent function gives the advantage that the user can independently achieve a desired effect based on an interaction with a related functional agent, i.e. without tracking or detecting at least one personal user feature. This is advantageous for the case that a certain effect desired by a user is practically impossible to detect by analyzing at least one personal user feature. One example of this may be a desire by a user to use a functional agent to curb their appetite. Also, a user may create a desired effect that is not comprised or even contrary to a suggestion based on analyzing at least one personal user feature. For example, after having slept badly, a user having a free day wants to sleep in and wishes to facilitate this by using a sleep supporting functional agent in the morning.

Alternatively, the at least one functional agent is added without user interaction.

It is an additional or alternative embodiment that the fragrance dispensing apparatus tracks or detects at least one personal user feature and adds at least one functional agent to the fragrance blend based on at least one tracked personal user feature. To this effect, the fragrance dispensing apparatus may comprise at least one sensor and/or may be connected to at least one external sensor. The connection to the at least one sensor may be a real-time connection.

For example, one or more of the following sensors/detectors or sensor/detector systems may be used:

At least one sensor or sensor system for sensing a user's facial micro-expression(s). Such a sensor may comprise a camera and an image processing unit. The camera may capture an image of a user's face. The image processing unit extracts the facial micro expressions (e.g. by polygonization) to compare them against a known base data. The result of this comparison may be used to identify a current mood of the user.

At least one sleep sensor or sensor system. These sensors may be placed underneath a mattress to track user's movements during the night. Such sensors may achieve approximately 97 percent accurateness at reading a sleep patterns. The fragrance dispensing apparatus may use that info to generate sleep reports each morning, complete with tailored advice on how to achieve a better start into the day and/or on how to get a better night's rest. To this end, the fragrance dispensing apparatus may propose to produce a fragrance blend that comprises at least one functional agent which achieves an energizing mood in the morning or a relaxing mood in the evening.

A speech analysis sensor or sensor system. Such a sensor may comprise a microphone to capture a user's voice/speech and a voice processing unit. A multi-parametric approach can be followed to estimate mood states by integrating information from the analysis of the user's voice/speech. The voice processing unit may comprise or be programmed with an algorithm to estimate speech features to characterize a user's mood state. This algorithm may be based on an automatic segmentation of speech signals to detect voiced segments, and on a spectral matching approach to estimate pitch and pitch changes.

A heart beat sensor or sensor system. This sensor may be used to track a user's heartbeat, e.g. to detect a raising or raised adrenaline level to identify when the user experiences a stress situation. Such a sensor may be integrated in a dedicated fitness sensor and/or in a smartwatch.

Other sensors or sensor systems may include a mydriasis (diameter of a pupil of the user's eye) sensor, a skin conductance sensor etc.

The fragrance dispensing apparatus may have a wired and/or a wireless interface to couple with an external sensor, in particular to read out data from the external sensor.

The user interface (also called man machine interface or “MMI”) allows a user to input choices of different types of active ingredients and their amount (e.g. in terms of weight, volume, vol.-% and/or percentage) as well as a type of fragrance blend (e.g., perfume, perfume water, toilet water, cologne, cologne water [i.e., liquid fragrance blends] or fragrance mist etc.). By utilizing a user interface, the fragrance dispensing apparatus may also offer the addition of at least one agent function and/or functional agent, in particular for improving the well-being of the user. The fragrance dispensing apparatus is adapted to automatically mix a respective user-selected or user-defined fragrance blend. The user interface may, e.g., comprise keys for inputting commands and/or selections and a display. The user interface may comprise a touchscreen.

The object is also achieved by a fragrance dispensing apparatus, wherein the fragrance dispensing apparatus is adapted to perform the method as described above.

In particular, the fragrance dispensing apparatus may comprise: at least one seat for at last one fragrance reservoir and at least one functional agent reservoir, a user interface for selecting at least one fragrance and at least one agent function or functional agent, at least one extraction means for extracting the selected at least one fragrance from the at last one fragrance reservoir and for extracting at least one functional agent corresponding to the selected at least one agent function or functional agent from the at last one functional agent reservoir, and a fragrance dispenser for dispensing a fragrance blend blended from the extracted at least one fragrance and at least one functional agent.

This fragrance dispensing apparatus gives the advantage that it enables instantly creating custom-made or tailor-made fragrance blends having functional agents. There is a high degree of flexibility in creating the fragrance blend since this is not restricted to choosing from pre-defined blends. There is also a high degree of user-friendliness since this creating of custom-made or tailor-made fragrance blends can be performed by the user itself or in the presence of the user.

The seat may also be called a compartment, receptacle, cavity, or support and holds a reservoir. In the following, a reservoir adapted to hold a fragrance and/or a functional agent may be called an “ingredient reservoir”.

For example, selecting the at least one functional agent to the fragrance blend may be performed automatically by the fragrance dispensing apparatus and/or on the basis of a user selection. In an embodiment the fragrance dispensing apparatus is adapted to offer, e.g. via a user interface, at least one desired agent function for selection to a user and at least one corresponding functional agent is automatically added to the fragrance blend based on the at least one selected agent function. Alternatively, the fragrance dispensing apparatus may be adapted to show or offer some or all available agent functions (e.g., mood enhancing, appetite curbing etc.) and/or related functional agents. Therefore, the fragrance dispensing apparatus may also be adapted to directly show or offer some or all functional agents. Also, the fragrance dispensing apparatus may offer to provide a fragrance blend comprising agent functions and/or offer functional agents based on the result of a tracking process, e.g. of sensing a user's mood etc.

It is an embodiment that the fragrance dispensing apparatus comprises at least one solvent reservoir for at least one solvent, wherein the user interface is adapted to allow selecting a type of the fragrance blend, wherein the at least one extraction means is adapted to additionally extract at least one solvent from at least one solvent reservoir, and wherein the fragrance dispenser is adapted to dispense a fragrance blend additionally containing the extracted solvent. The provision of the at least one solvent reservoir gives the further advantage that a type of fragrance can be selected instantly (e.g., perfume, perfume water, toilet water, cologne, cologne water, fragrance mist etc.). Additionally, a volume of the ingredient reservoir(s) can be kept small that way, enabling a compact design and/or a large number of ingredient reservoirs. This embodiment takes into account that an ingredient reservoir may comprise active ingredients of a stock solution of a pre-determined—typically high—concentration. For use in a fragrance blend, the stock solution may have to be diluted by adding solvent to some lower concentration for actual use. The solvent may comprise at least one component like alcohol (e.g. ethanol), glycol and/or water and eventually at least one fixative. In particular, depending on its dilution, a fragrance blend may be offered as perfume (from 20 vol.-% to 40 vol.-% of stock solution diluted in ethanol and/or water as solvents), perfume water (from 10 vol.-% to 20 vol.-% of stock solution diluted in ethanol and water), toilet water (from 5 vol.-% to 10 vol.-% of stock solution diluted in ethanol and water), cologne (from 3 vol.-% to 5 vol.-% of stock solution diluted in ethanol and water), cologne water (from 1 vol.-% to 3 vol.-% of stock solution diluted in ethanol and water), or fragrance mist and air freshener (with less than 1 vol.-% of stock solution diluted in ethanol and water), etc. In particular, the liquid fragrance is not intended to be used for food or other alimentary purposes. The stock solutions may be stored as solids (e.g. a powder), gels and/or liquids.

Generally, the fragrance dispensing apparatus may be embodied in analogy to the fragrance dispensing method. For example, the fragrance dispensing apparatus may comprise at least one integrated sensor and/or sensor system and/or may be connectable to an external sensor and/or sensor system to track at least one personal user feature, e.g. a mood or emotion, etc.

A reservoir may be a removable or exchangeable reservoir. In this case, the reservoir may also be called a “cartridge”. The cartridge may comprise exactly one reservoir and may then also be called a “capsule”. Alternatively, the cartridge may comprise several reservoirs (e.g. several capsules) containing different active ingredients. This gives the advantage that a user may individually choose and replace the kind of fragrances and functional agents. The fragrance dispensing apparatus may comprise at least one seat for several reservoirs, e.g. at least one seat for one or more (multi-reservoir) cartridges and/or several seats for capsules (single-reservoir cartridges). At least one reservoir may alternatively be fixedly positioned in the fragrance dispensing apparatus. In this case, the reservoir may be called a tank. Such a tank may be refillable by a user. A solvent tank may comprise one solvent (e.g. water, alcohol, glycerine) or a solvent mixture (e.g. a mixture of water and alcohol). The reservoirs, and in particular a tank, may be equipped with a level sensor. The fragrance dispensing apparatus may comprise at least one seat for a removable reservoir for an active ingredient and at least one tank for at least one solvent. In particular, the fragrance dispensing apparatus may comprise at least one seat for a fragrance/functional agent cartridge and at least one solvent tank.

In one embodiment at least one seat or reservoir is connectable or connected to a respective extraction means via a respective coupling means (also called a connector). The coupling means is adapted to prevent unwanted spill or leakage from the respective reservoir and to connect the reservoir to the extraction means. The coupling means may be opened to generally allowing discharging the reservoir's content. In one variant, the coupling means comprises a valve. The valve may e.g. be a one-way valve. For example, the valve may be a pressure operated valve, a pinch valve, a needle valve etc. In another variant, the reservoir's outlet is sealed with a rubber cap that works as dropper or dosage means. In yet another variant, a hollow needle can be inserted into the reservoir through the rubber cap to extract content from the reservoir. The rubber cap makes a tight connection with the needle, and once the needle is pulled out of the reservoir, the rubber cap recovers its shape thanks to its elastic properties thus avoiding spillage of the remaining content. The needle may be a part of the extraction means while the rubber seal may be regarded as the coupling means.

The extraction means (or “extractor”) may comprise at least one dosing means to precisely control the amount (e.g. weight, flow volume etc.) of the active ingredient(s) and solvent(s) dispensed or extracted from the reservoirs. The dosing means may comprise or be a precisely controllable dosage valve. The extraction means may further comprise a pump for pumping the active ingredient(s) and eventually solvent(s) from the reservoirs.

This supports a constant and precise flow of the reservoir's content. For example, the pump may be a peristaltic pump. Additionally, the extraction means may comprise a flow meter for measuring the amount of active ingredient(s) and eventually solvent(s) dispensed or extracted. This allows a particularly precise measurement and extraction of the reservoir's content. Regarding a flow direction of the reservoir's contents, the extraction means is positioned between at least one reservoir and the fragrance dispenser. The fragrance dispenser may also be called a fragrance dispensing means, a fragrance dispensing module or a fragrance dispensing component. It is an embodiment that each reservoir is connected to a respective extraction means (e.g. via a respective coupling means). This enables a particularly precise extraction or dosing and avoids an unwanted mixture of fragrances and agents.

It is another embodiment that at least one extraction means is simultaneously/parallely connectable or connected only to at least one ingredient reservoir (e.g. via a respective coupling means) and at least one other extraction means is simultaneously connectable or connected only to at least one solvent reservoir (e.g. via a respective coupling means). This allows a precise and fast dosing and reduced costs. In particular, an extraction means connectable to a solvent reservoir may have a greater flow-rate than an extraction means connectable to an ingredient reservoir which allows fast dispensing of the solvent. This makes use of the fact that a solvent quantity needed for the fragrance blend is typically much higher than the quantity needed for the fragrances and functional agents. In one variant, exactly one extraction means is connected or connectable to the ingredient reservoir(s) and exactly one other extraction means is connected or connectable to the solvent reservoir(s). Both extraction means may comprise a respective pump and flow meter.

It is yet another embodiment that at least one extraction means is simultaneously connectable or connected to at least one ingredient reservoir and additionally connectable or connected to at least one solvent reservoir. This allows a particularly cost effective extraction. In particular, the at least one extraction means comprises exactly one extraction means that is connectable or connected to all reservoirs. The connection between the extraction means and the reservoir, its seat, or its valve, respectively, may comprise using a tube, pipe, duct or other conduit.

It is even another embodiment that the at least one extraction means comprises an extractions means for consecutively being connectable or connected to several reservoirs. For example, such an extraction means may comprise a needle. By moving the needle and/or the reservoirs, the needle may be consecutively inserted into selected reservoirs to extract the respective content (i.e. fragrance(s), functional agent(s) and/or solvent(s)). The movement may e.g. be performed by a step motor. In particular, this embodiment comprises exactly one extraction means which allows an especially cost-effective setup. Also, the coupling means may not be needed/may be avoided in this embodiment. For example, the reservoirs may comprise rubber seals hermetically sealing an opening to allow a tight fit of the needle and a reliable closure after the needle has been removed.

It is yet another embodiment that the fragrance dispensing apparatus comprises a blending chamber for blending the extracted fragrance(s), functional agent(s) and/or eventually the solvent(s) into a fragrance blend. If the blending chamber is present, the pump may be used for pumping the contents(s) from the reservoir(s) to the blending chamber. Regarding a flow direction of the reservoir's contents, the extraction means may be positioned between at least one reservoir and the blending chamber. It is an embodiment thereof that the blending chamber is a “static” chamber that simply holds the extracted reservoir's contents. This is a particularly cost-effective embodiment. The contents may be kept for a predefined time to enhance the homogeneity of the fragrance blend. It is another embodiment thereof that the blending chamber is a “continuous” chamber in that the extracted contents are blended based on a loss of pressure when they are flowing together through the blending chamber. It is yet another embodiment thereof that the blending chamber is a “bubbling” chamber which is based on creating bubbles at the bottom of the blending chamber that will circulate upwards through all the contents thus speeding up the blending process. The bubbles may be created by an air pump and e.g. membranes at the bottom of the blending chamber. It is even another embodiment thereof that the blending chamber comprises a mixing blade. The mixing blade may be driven by a rotor. Such a blending chamber works with powder-liquid and liquid-liquid blends. In particular, the blending chamber may form a close-clearance mixer. There are several types of close-clearance mixers, most common ones use mixing blades in form of anchors or helical ribbons. Anchor mixers induce solid-body rotation but do not promote vertical mixing, while helical ribbons do promote vertical mixing. Other types of close-clearance mixers may use Rushton blades, hydrofoil blades, radial blades, axial blades etc.

It is an embodiment that the fragrance dispensing apparatus comprises an identification means for identifying the reservoirs, in particular cartridges, in particular ingredient cartridges, and the contained fragrances and functional agent, respectively. This allows a fast and reliable identification of the reservoirs and facilitates replacing or newly inserting cartridges into the fragrance dispensing apparatus. To this effect, identification technologies like optical reading (e.g. barcode scanning), RFID querying (e.g., NFC) and so on can be used. In one variant, the identification means (or “identificator”) comprises an optical code reader (e.g. light and/or IR scanner) to read a code (e.g. a barcode or a QR code) of the cartridges. For example, there is provided one code reader for each cartridge to identify the cartridge's content. The readers may be placed at a certain distance from each cartridge. This is a particularly affordable variant if the fragrance dispensing apparatus may only contain a small number of cartridges. In another variant, the identification means comprises a wireless radio frequency reader, e.g. a RFID reader, in particular an NFC reader. This variant has the advantage that one reader may be sufficient to read respective RFID tag of multiple, in particular all, cartridges. The cartridges are consequently equipped with such RFID tags. This variant has the further advantage that a distance and orientation of the RFID reader with respect to the RFID tags may be more flexible. The reader(s) may be placed at a fixed location or at fixed locations within the fragrance dispensing apparatus. In an alternative, a reader may be moved or movable within the fragrance dispensing apparatus such that the reader may be placed in front of each code/tag. This is particularly advantageous when using an optical reader. Alternatively, the cartridges may be moved to the fixed reader. This identification means may comprise a rotor that rotates the seats of the cartridges or that rotates the reader for a direct reading, in particular optical reading.

It is an embodiment that the fragrance dispenser is adapted to apply at least one active ingredient directly (i.e., circumventing the blending chamber, if present) to a test substrate and to provide this test substrate. This allows a customer to smell a single active ingredient and/or fragrance mix before ordering the fragrance dispensing apparatus to process the final fragrance blend.

In one variant, the test substrate is a test strip, e.g. made of blotting paper. In this case, the fragrance dispensing apparatus may comprise a test strip dispenser where the test strip is provided with (e.g. sprayed with) one or more active ingredients. The customer can take the strip to smell the sample. In another—even simpler—variant, the customer takes one test strip from the test strip dispenser and rubs it against a surface that contains the sample fragrance and/or functional agent.

The fragrance dispensing apparatus may be adapted to allow a customer to smell single active ingredients the customer wants to add to the fragrance blend. To this effect, the extraction means may be adapted to put a drop of the requested active ingredient onto the test strip. The customer can take the test strip and smell it. Additionally or alternatively, the fragrance dispensing apparatus may be adapted to allow a customer to smell multiple active ingredients. In this case, to achieve a good approximation of the desired fragrance blend, the extraction means may extract and dispense the multiple active ingredients in the right proportions. The customer may shake the test strip to let the active ingredients mix.

In yet another variant, the test substrate is housed in a tube (“test tube”). The test substrate may be ceramic wool or any other suitable absorbent material. The active ingredient(s) is or are dispensed into the test tube. The test tube may comprise a heater that heats the ceramic wool once the customer wants to smell the sample. The heater may be working until the customer wants to test another active ingredient(s) or until the active ingredient(s) has or have totally evaporated. The test tube may be part of the fragrance dispensing apparatus and may not be removable.

The fragrance dispenser may e.g. dispense the test fragrance/functional agent mix as a liquid or as a spray. It is an embodiment that the fragrance dispenser is adapted to dispense the selected or automatically determined active ingredients into a withdrawable container, e.g. into a bottle. Fragrance bottles have the advantage to have a perceived high value. The fragrance dispenser may comprise a flow meter to precisely measure the amount of the fragrance blend let into the withdrawable container. Additionally, the fragrance dispenser may comprise a pump to pump the fragrance blend into the withdrawable container. In particular for the case that the fragrance dispensing apparatus comprises a blending chamber, the fragrance dispenser may be adapted to dispense a ready fragrance blend from the blending chamber into the withdrawable container. In this embodiment, the fragrance dispenser may comprise a valve, in particular dosage valve, to let the ready fragrance blend out of the blending chamber. The fragrance dispenser may comprise a flow meter to precisely measure the amount of the fragrance blend let out of the blending chamber and into the withdrawable container. Additionally, the fragrance dispenser may comprise a pump to pump the fragrance blend from the blending chamber into the withdrawable container. Alternatively, and particular for the case that the fragrance dispensing apparatus does not comprise a blending chamber, the fragrance dispenser is adapted to dispense the selected active ingredient(s) and eventually the solvent(s) directly into a withdrawable container, e.g. into a bottle.

It is an additional or alternative embodiment that the fragrance dispenser comprises a fragrance spraying device to directly spray the ready fragrance blend from the fragrance dispensing apparatus. The fragrance spraying device may comprise a spray nozzle. The spray nozzle may be activated by a customer, e.g. being mechanically activated by pressing it. Therefore, the fragrance dispenser may be adapted to dispense the selected fragrance blend through the spray nozzle. This can be achieved directly or via the blending chamber.

It is an embodiment that the fragrance dispensing apparatus is a self-cleaning device. This enables to conveniently remove active ingredient(s) that have been left over from a dispensing process. Such leftover active ingredient(s) may rest in pipes, pumps, the blending chamber etc., or even external components. The fragrance dispensing apparatus may start a self-cleaning process, e.g. automatically and/or by user command. For example, the self-cleaning process may dispense a certain amount of solvent (e.g. ethanol) in order to dissolve and remove leftover traces of the active ingredient(s). In one variant, at least one solvent used for creating the fragrance blend may be used. This is typically sufficient since most active ingredients are soluble. In an alternative or additional variant, dedicated cleaning chemicals may be used, e.g. contained in a specific cleaning reservoir.

To avoid or slow down a degradation of the active ingredients, fragrance reservoirs with a reduced amount of oxygen may be used. Rather, the fragrance reservoirs may comprise a protective atmosphere, e.g. made up of nitrogen and/or carbon dioxide. Also, the fragrance bottles given out from the fragrance dispensing apparatus may comprise the fragrance blend in such a protective atmosphere.

It is an embodiment that the fragrance dispensing apparatus comprises a control device (e.g. a microcontroller, control module, control board, etc.) to operate the fragrance dispensing apparatus according to selections made by a user at the user interface. The control device may e.g. operate one or more from the group containing the extraction means, the blending chamber, the fragrance dispenser etc.

It is an embodiment that at least one disposable cartridge comprising at last one fragrance reservoir and at least one functional agent reservoir is inserted into the at least one seat.

The above described features and advantages of the invention as well as their kind of implementation will now be schematically described in more detail by at least one embodiment in the context of one or more FIGURES of the attached drawing.

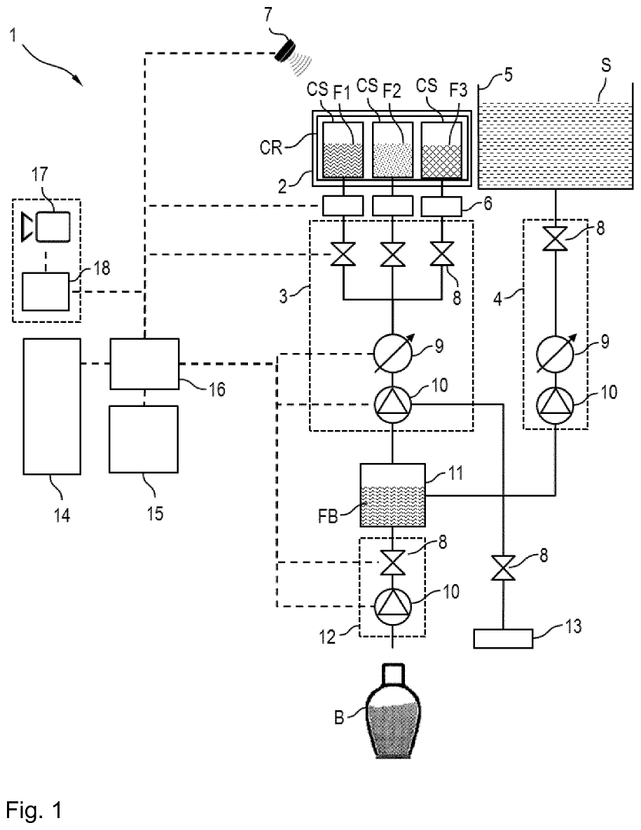

FIG. 1 shows a schematic drawing of a fragrance dispensing apparatus 1. The fragrance dispensing apparatus 1 comprises a seat 2 for a cartridge CR. The cartridge CR exemplarily comprises three ingredients reservoirs in form of capsules CS. The capsules CS contain stock solutions of different liquid active ingredients, e.g. two fragrances F1, F2 and a functional agent F3. The fragrances may comprise a single odorant or a mix of several odorants. The functional agent F3 may e.g. be a mood enhancing scent, e.g. a stimulating scent.

The fragrance dispensing apparatus 1 further comprises one extraction means 3 for selectively extracting the active ingredients F1, F2, F3 from the capsules CS and one extraction means 4 for extracting a solvent S (e.g. an ethanol/water mix) from a solvent tank 5. While the cartridge CR is removable by a user, the solvent tank 5 is fixedly positioned in the fragrance dispensing apparatus 1. The capsules CS and/or the solvent tank 5 may be equipped with a level sensor (not shown).

The outlets of the capsules CS are each connected to the extraction means 3 via respective coupling means 6 or connectors, e.g. in form of one-way valves. The extraction means 3 can selectively extract the active ingredients F1, F2, F3 from the capsules CS.

To identify the active ingredients F1, F2, F3, the fragrance dispensing apparatus 1 comprises an identification means in form of an optical or radio frequency reader 7 that reads a respective code or tag of the cartridge CR. The queried information may include the kind of fragrance(s) or functional agent, their initial amount, dilution, etc. Alternatively or additionally, a code or tag may be associated with each of the capsules CS.

The extraction means 3 comprises dosage valves 8 that are connected to a respective coupling means 6. The dosage valves 8 enable extracting a very precise amount of active ingredients F1, F2 and/or F3. The dosage valves 8 are connected to a flow meter 9 which, in turn, is connected to a pump 10. The pump 10 is connected to a blending chamber 11. The blending chamber 11 is also connected to the solvent tank 5 via the extraction means 4. While the extraction means 4 may have a generally similar setup (e.g. comprising a dosage valve 8, a flow meter 9, and a pump 10) as the extraction means 3, it may have a larger flow-rate than the extraction means 3. Also, there may not be a coupling means 6 between the solvent tank 5 and the extraction means 4.

The blending chamber 11 is used to blend the active ingredients F1, F2 and/or F3 extracted from the capsules CS and eventually the solvent S extracted from the solvent tank 5 to create a fragrance blend FB. The blending chamber 11 may be a static chamber, a continuous chamber, a bubbling chamber, a mixing chamber (e.g. a close-clearance mixer), etc.

Further, the blending chamber 11 is connected to a fragrance dispenser 12 for dispensing the blended fragrance mixture FB from the blending chamber 11 into a fragrance bottle B.

The fragrance dispenser 12 may comprise a dosage valve 8, a pump 10, and/or a flow meter (not shown). Alternatively or additionally, the fragrance dispenser 12 may comprise a fragrance spraying device (not shown), e.g. a spray nozzle.

An output side of the extraction means 3 is also connected to a test strip dispenser 13 via an optional dosage valve 8 for dispensing at least one active ingredient F1, F2, F3 stored in the capsules CS onto a substrate in form of a test strip (not shown) and providing the test strip. A pump and/or a flow meter (not shown) may also be present between the extraction means 3 and the test strip dispenser 13. Thus, the active ingredients F1, F2, and/or F3 may be directly applied to the test strip. The fragrance dispensing apparatus 1 is adapted to selectively extract the active ingredients F1, F2, and/or F3 towards the blending chamber 11 or the test strip dispenser 13. Alternatively or additionally to the test strip dispenser 13, a spray nozzle may be used. Alternatively to the test strip dispenser 13, the fragrance dispensing apparatus 1 may comprise a heatable open test tube (not shown) that contains a substrate for the fragrance(s) dispensed from the extraction means 3. To this effect, a 3/2-way valve (not shown) or such may be used.

The fragrance dispensing apparatus 1 further comprises a user interface 14 for selecting one or more of the active ingredients F1, F2, and/or F3 and for eventually selecting a type/dilution of the desired fragrance blend FB to be blended in the blending chamber 11. A user may also use the user interface 14 for selecting the active ingredients F1, F2, and/or F3 to be dispensed onto the test strip etc.

Additionally, the fragrance dispensing apparatus 1 comprises a communication module 15, e.g. for communicating a need to replace the cartridge CR or to fill up the solvent tank 5.

Moreover, the fragrance dispensing apparatus 1 comprises a control device 16 (e.g. a control module comprising a microcontroller, an ASIC, a FPGA etc.) to operate or use the fragrance dispensing apparatus 1, e.g. some or all of its electrically controllable components 3 to 4, 5 (its level sensor), 6 to 14. For example, by activating the reader 7, the control device 16 identifies the available active ingredients F1 to F3 and may calculate their remaining amount. Also, the control device 16 has information about the available solvent S and its amount. The control device 16 may thus present available selections/choices in the user interface 14. The control device 16 may also present the possibility to test the available active ingredients F1 to F3 in the user interface 14.

Furthermore, the fragrance dispensing apparatus 1 comprises an optical sensor 17, 18 for sensing or detecting a user's facial micro-expressions. The sensor comprises a camera 17 and an image processing unit 18. The camera 17 captures an image of a user's face, either triggered by a user command via the user interface 14 or automatically. The image processing unit 18 extracts the facial micro expressions (e.g. by polygonization). The result of this comparison may be used to identify a current mood of the user. To this effect, the image processing unit 18 may send information regarding the user's current mood result to the control device 16. Alternatively, the control device 16 may be the image processing unit 18.

In one possible user scenario, a user approaches the fragrance dispensing apparatus 1. The fragrance dispensing apparatus 1 may be installed at a shopping mall, in an office building etc. or may be a household apparatus. The user interface 14 may offer to provide a fragrance blend FB with or without using a functional agent F3.

If the user selects providing a fragrance blend FB without functional agent F3, the user may then be offered to test one or more of the fragrances F1, F2. If the user selects testing the fragrances F1 and/or F2, the control device 16 opens the respective coupling means 6 and operates the respective dosing valve(s) 8 of the extraction means 3 to extract a small quantity from the respective capsule(s) CS, e.g. one after another for the case that the user has selected more than one fragrance F1, F2. By command of the control device 16, the pump 10 of the extraction means 3 pumps the fragrance(s) F1, F2 via the open dosage valve 8 to the test strip dispenser 13. The fragrance(s) F1 and/or F2 are applied to a test strip, and the test strip is presented to the user.

If—after testing or alternatively to testing—the user selects to receive a bottle B of a certain fragrance blend FB, the user is prompted to input the desired one or more fragrances F1, F2, their amount, and the type of the desired fragrance blend FB (perfume, cologne etc.). The control device 16 then opens the respective coupling means 6 and operates the respective dosing valve(s) 8 of the extraction means 3 to extract the selected amount or quantity from the respective capsule(s) CS, e.g. one after another. The pump 10 of the extraction means 3 pumps the fragrance(s) F1 and/or F2 into the blending chamber 11. Similarly, the control device 16 commands the extraction means 4 to extract a quantity of the solvent S into the blending chamber 11. The quantity of the solvent S is determined by the control device 16 on basis of the selected or desired type of fragrance blend FB. The quantities of the fragrance(s) F1 and/or F2 and the solvent S are measurable by the flow meter(s) 9. The control device 16 may also operate the blending chamber 11, if available. Moreover, the control device 16 operates the fragrance dispenser 12 to dispense the ready fragrance blend FB into the bottle B.

If the user selects providing a fragrance blend FB with the functional agent F3, the fragrance dispensing apparatus 1 then offers to detect the user's mood by activating the optical sensor 17, 18. After having the mood detected, the fragrance dispensing apparatus 1 displays the result in the user interface 14. The fragrance dispensing apparatus 1 may then query the user whether an addition of the functional agent F3, i.e. the mood enhancing scent, is desired. If the answer is yes, the functional agent F3 will be added to the fragrance blend FB. If, for example, the fragrance dispensing apparatus 1 determines that the user is tired, the stimulating functional agent F3 is offered to be added.

If the fragrance dispensing apparatus 1 has more than one functional agent F3 that acts on a mood/emotion of a user (e.g. a stimulating scent and a relaxing scent), the fragrance dispensing apparatus 1 may offer the respective functional agent F3. The offer may also be dependent on other factors, e.g. a time of the day. If, for example, the fragrance dispensing apparatus 1 determines that the user is tired, it may offer to add a stimulating functional agent F3 in the morning but not in the evening.

The fragrance dispensing apparatus 1 may also be adapted to let the user freely choose any functional agent F3 available.

The fragrance dispensing apparatus 1 may be adapted to store and offer previous user selections so as to facilitate the selectin process.

Selecting the fragrances F1 and/or F2 to be added to the fragrance blend FB may be performed before or after selecting the functional agent F3.

The fragrance dispensing apparatus 1 may be a self-cleaning device.

Of course, the invention is not restricted to the described embodiments. For example, the fragrance dispensing apparatus 1 may comprise more than one cartridge CR. The cartridge CR may comprise more than three capsules CS. The fragrance dispensing apparatus 1 may comprise other sensors than the optical sensor 17, 18. The fragrance dispensing apparatus 1 may comprise an e.g. wireless interface to connect to an external sensor, e.g. in form of a WLAN module, a Bluetooth module, etc. The communication module 15 may be this wireless interface.

### LIST OF REFERENCE NUMERALS

1 fragrance dispensing apparatus
2 seat
3 extraction means
4 extraction means
5 solvent tank
6 coupling means
7 reader
8 dosage valve
9 flow meter
10 pump
11 blending chamber
12 fragrance dispenser
13 test strip dispenser
14 user interface
15 communication module
16 control device
17 camera
18 image processing unit
B bottle
CR cartridge
CS capsule
FB fragrance blend
F1 fragrance
F2 fragrance
F3 functional agent
S solvent

1. A method for dispensing a fragrance blend comprising at least one fragrance, wherein the method comprises, by a fragrance dispensing apparatus,
offering at least one desired agent function for user selection,
blending at least one fragrance with at least one functional agent based on at least one selected agent function to obtain the fragrance blend and
dispensing the fragrance blend.

2. The method according to claim 1, wherein offering at least one desired agent function is followed by offering to add at least one functional agent corresponding to the at least one selected agent function.

3. The method according to claim 1, wherein at least one functional agent is an anti-aging agent.

4. The method according to claim 1, wherein at least one functional agent is an appetite curbing agent.

5. The method according to claim 1, wherein at least one functional agent is a hormone balance agent.

6. The method according to claim 1, wherein at least one functional agent is a memory triggering agent.

7. The method according to claim 1, wherein
the fragrance dispensing apparatus tracks at least one personal user feature and
adds at least one functional agent to the fragrance blend based on at least one tracked personal user feature.

8. The method according to claim 1, wherein the functional agent is an odourless agent.

9. A fragrance dispensing apparatus, comprising:
at least one seat for at last one fragrance reservoir and at least one functional agent reservoir,
a user interface for selecting at least one fragrance and at least one agent function,
at least one extraction means for extracting the selected at least one fragrance from the at last one fragrance reservoir and for extracting at least one functional agent corresponding to the selected at least one agent function from the at last one functional agent reservoir, and
a fragrance dispenser for dispensing a fragrance blend blended from the extracted at least one fragrance and at least one functional agent.

10. The fragrance dispensing apparatus according to claim 9, comprising
at least one solvent reservoir for at least one solvent,
wherein the user interface is adapted to allow selecting a type of the fragrance blend,
wherein the at least one extraction means is adapted to additionally extract at least one solvent from at least one solvent reservoir, and
wherein the fragrance dispenser is adapted to dispense a fragrance blend comprising the extracted solvent.

11. The fragrance dispensing apparatus according to claim 9, wherein the fragrance dispensing apparatus comprises a sensor and/or is connectable to an external sensor to track at least one personal user feature.

12. The fragrance dispensing apparatus according to claim 9, wherein at least one disposable cartridge comprising at last one fragrance reservoir and at least one functional agent reservoir is inserted into the at least one seat.
